(19) United States
(12) Patent Application Publication
(10) Pub. No.: US 2025/0201505 A1
(43) Pub. Date: Jun. 19, 2025

(54) CHIP-TYPE FUSE

(71) Applicant: Chun-Hsia Chen, Taoyuan City (TW)

(72) Inventor: Chun-Hsia Chen, Taoyuan City (TW)

(73) Assignee: ONANO INDUSTRIAL CORP., Taoyuan City (TW)

(21) Appl. No.: 18/542,525

(22) Filed: Dec. 15, 2023

(51) Int. Cl. H01H 85/175; H01H 85/00; H01H 85/041; H01H 85/06; H01H 85/08

(52) U.S. Cl. CPC H01H 85/1755; H01H 85/0013; H01H 85/0411; H01H 2085/0414; H01H 85/06; H01H 85/08

(57) ABSTRACT

A fuse includes a circuit layer, a thermal resistance layer, a base layer and a top layer. The circuit layer includes a fuse wire and two inner electrodes. The inner electrodes are separately connected to two ends of the fuse wire. The thermal resistance layer is superposed to the circuit layer and has a thermal resistance room and two first conductors. The first conductors are disposed in the thermal resistance layer. Each first conductor is connected to one of the inner electrodes. The base layer is closely superposed to the thermal resistance layer and has two outer electrodes on the base layer, two second conductors in the base layer and a degassing passage in the base layer correspondingly to the thermal resistance room. The second conductor is connected to the outer electrode and the first connector. The top layer is closely superposed to the circuit layer.

### BACKGROUND

### Technical Field

The invention relates to fuses, particularly to a chip-type fuse.

### Related Art

A fuse is an indispensable component of circuits. Its main function is to immediately interrupt the circuit operation when the temperature or current exceeds a threshold value to protect other circuit components. Chip-type fuses have characteristics of small size, light weight, and good surge current tolerance, and have been widely used in various electronic devices. Based on the requirement of products having to be light, thin and compact, the low temperature co-fired ceramic (LTCC) technology has been introduced into chip-type fuse products. Chip-type fuses are printed and sintered on a ceramic substrate to make a circuit layer. Multiple layers of ceramic substrates are superposed to form a ceramic integrated mold by the LTCC process. A fuse wire is encapsulated in the ceramic integrated mold, and then terminal electrodes are formed on both sides of the exterior of the ceramic integrated mold by a dipping process. And two ends of the fuse wire are separately connected to the terminal electrodes. Usually, in order to ensure the electrical connection between the fuse wire and the terminal electrodes, the dipping process needs to be carried out repeatedly. However, the dipping process of traditional chip-type fuses is mostly done manually. It is difficult to mass-produce and costs a lot. In addition, because the ceramic substrate has a thermal conductive effect and the thickness of the board is thin, when an electronic circuit is operated and an overcurrent occurs, the heat generated by the fuse wire may be directly dissipated into the environment by the ceramic substrate, resulting in no melting or delayed melting of the fuse wire. This will lose the role of a fuse as circuit protection, thereby increasing the risk of damage to electronic equipment. Therefore, how to avoid a chip-type fuse from being disabled in its fusing operation and reduce the processing cost of the dipping process is an issue that needs to be solved urgently.

### SUMMARY

An object of the invention is to provide a chip-type fuse with high safety and high reliability. It uses the LTCC technology to encapsulate a fuse wire in a ceramic integrated mold. The fuse wire is disposed with an overcurrent melting portion. A corresponding position of the overcurrent melting portion is disposed with a chamber-type thermal resistance structure to block outward transmission of heat generated by the melted fuse wire. This can prevent the electronic circuit from being damaged. Also, the heat can be concentrated at the overcurrent melting portion of the fuse wire. The chamber-type thermal resistance structure can also provide accommodation for molten shavings to avoid the situation of overflow of molten shavings or the capillary action causing the power to remain uninterrupted even after blowing. Accordingly, it can be ensured that the fuse wire can surely blow out to implement the function of circuit protection when overload occurs.

Another object of the invention is to provide a chip-type fuse with outer contacts. It uses the LTCC technology to electrically connect the fuse wire encapsulated in the ceramic integrated mold to the outer electrodes exposed on the surface, which is beneficial to installing the chip-type fuse in an electric circuit by soldering or the surface mount technology to simplify the manufacturing process, save costs and improve the yield rate.

To accomplish the above objects, the invention provides a chip-type fuse which includes a circuit layer, a thermal resistance layer, a base layer and a top layer. The circuit layer includes a dielectric substrate which is a ceramic layer. The dielectric substrate is disposed with a fuse wire and two inner electrodes. The fuse wire is disposed with an overcurrent melting portion. The two inner electrodes are separately disposed on two side edges of the circuit layer and electrically connected to two ends of the fuse wire. The thermal resistance layer is a ceramic layer, closely superposed to the circuit layer and disposed with a thermal resistance room and two first conductors. The thermal resistance room is a hollow chamber and located at a corresponding position of the overcurrent melting portion. The two first conductors pass through to be disposed in the thermal resistance layer. Each first conductor is separately electrically connected to one of the inner electrodes. The base layer is a ceramic layer, closely superposed to the thermal resistance layer, and disposed with two outer electrodes, two second conductors and a degassing passage. The two outer electrodes are separately disposed on two side edges of a lower surface of the base layer. The two second conductors pass through to be disposed in the base layer. Each second conductor is separately electrically connected to one of the outer electrodes and one of the first connectors. The degassing passage passes through to be disposed in the base layer and located at a corresponding position of the thermal resistance room. The top layer is a ceramic layer and closely superposed to the circuit layer.

In an embodiment of the invention, the overcurrent melting portion is less than the fuse wire in circuit cross-section area, the overcurrent melting portion is lower than the fuse wire in material melting point or the overcurrent melting portion is higher than the fuse wire in material resistivity.

In an embodiment of the invention, the fuse wire is made of, but not limited to, silver, copper, tin or an alloy thereof or a mixture thereof.

In an embodiment of the invention, the first conductors and the second conductors are made of gold, silver, copper or an alloy thereof or a mixture thereof.

In an embodiment of the invention, the inner electrodes and the outer electrodes are made of gold, silver, copper or an alloy thereof or a mixture thereof.

In an embodiment of the invention, a second thermal resistance layer is closely superposed between the circuit layer and the top layer, and the second thermal resistance layer is a ceramic layer.

In an embodiment of the invention, the second thermal resistance layer is disposed with a second thermal resistance room, the second thermal resistance room is a hollow chamber and located at a corresponding position of the overcurrent melting portion.

In view of this, the inventors have devoted themselves to the above-mentioned prior art, researched intensively and cooperated with the application of science to try to solve the above-mentioned problems. Finally, the invention which is reasonable and effective to overcome the above drawbacks is provided.

### BRIEF DESCRIPTION OF THE DRAWINGS

FIG. 1 is a cross-sectional view of the first embodiment of the invention;

FIG. 2 is a plan view of the bottom surface of the circuit layer of the first embodiment of the invention;

FIG. 3 is a plan view of the bottom surface of the thermal resistance layer of the first embodiment of the invention;

FIG. 4 is a plan view of the bottom surface of the base layer of the first embodiment of the invention;

FIG. 5 is a cross-sectional view of the second embodiment of the invention;

FIG. 6 is a cross-sectional view of the third embodiment of the invention; and

FIG. 7 is a cross-sectional view of the fourth embodiment of the invention.

### DETAILED DESCRIPTION

In the following description, embodiments will be used to further illustrate the technical features of the present invention. In order to provide a clearer description and make it easier to understand the technical features of the present invention, various parts in the drawings are not drawn according to their relative sizes. Some sizes and other relevant scales have been exaggerated in comparison, and irrelevant details have not been fully depicted in order to keep the diagrams simple.

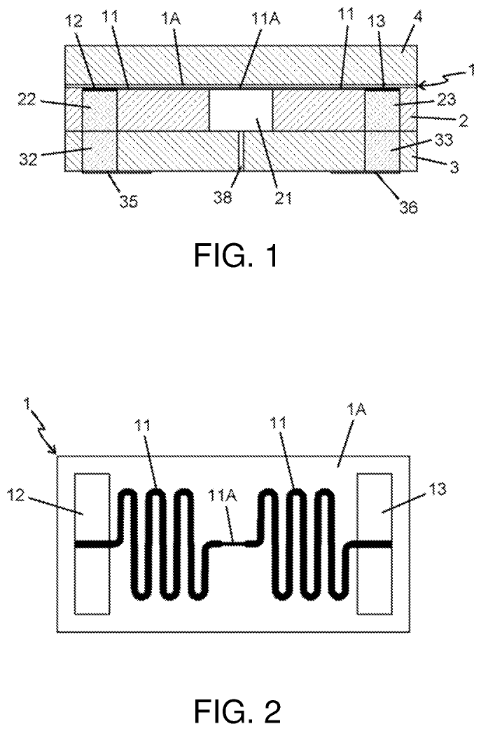

FIGS. 1-4 show the first embodiment of the chip-type fuse of the invention, which includes a circuit layer 1, a thermal resistance layer 2, a base layer 3 and a top layer 4.

As shown in FIGS. 1-2, the circuit layer 1 has a dielectric substrate 1A. The dielectric substrate 1A is disposed with a fuse wire 11 and two inner electrodes 12, 13. The fuse wire 11 is disposed with an overcurrent melting portion 11A. The overcurrent melting portion 11A can be disposed by various manners such as the overcurrent melting portion 11A is lower than the fuse wire 11 in material melting point, the overcurrent melting portion 11A is higher than the fuse wire 11 in material resistivity, or the overcurrent melting portion 11A is less than the fuse wire 11 in circuit cross-section area, that is, the overcurrent melting portion 11A is less than the fuse wire 11 in circuit width, thickness or both. The circuit cross-section areas of the aforementioned both depend upon the formulated rated current of fuse products. The two inner electrodes 12, 13 are separately disposed on two side edges of the circuit layer 1 and electrically connected to two ends of the fuse wire 11. The fuse wire 11 and the two inner electrodes 12, 13 can be formed on a surface of the circuit layer 1 by printing or sputtering. The inner electrodes 12, 13 are good conductors and made of, but not limited to, gold, silver, copper or an alloy thereof or a mixture thereof. The fuse wire 11 has a lower melting point than other conductive circuits to be able to blow out first when overcurrent occurs. The fuse wire 11 is made of, but not limited to, silver, copper, tin or an alloy thereof or a mixture thereof.

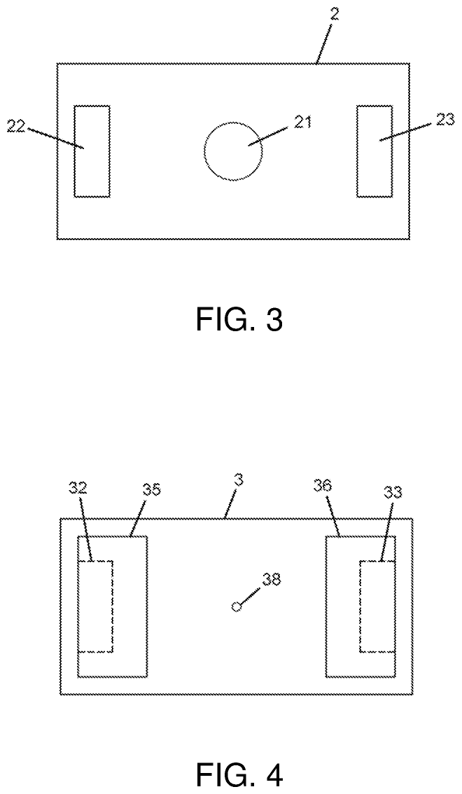

As shown in FIGS. 1 and 3, the thermal resistance layer 2 is disposed with a thermal resistance room 21 and two first conductors 22, 23. The thermal resistance room 21 is a hollow chamber with great thermal insulation and disposed at a corresponding position of the overcurrent melting portion 11A. The two first conductors 22, 23 pass through to be disposed in the thermal resistance layer 2. Each first conductor 22, 23 is separately electrically connected to one of the inner electrodes 12, 13. The first conductors 22, 23 can be formed by disposing through holes in the thermal resistance layer 2 and filling conductive material in the through holes. The first conductors 22, 23 are good conductors and made of, but not limited to, gold, silver, copper or an alloy thereof or a mixture thereof.

As shown in FIGS. 1 and 4, the base layer 3 is disposed with two outer electrodes 35, 36, two second conductors 32, 33 and a degassing passage 38. The two outer electrodes 35, 36 are separately disposed on two side edges of a lower surface of the base layer 3. The two outer electrodes 35, 36 can be formed on a lower surface of the base layer 3 by printing or sputtering. The two second conductors 32, 33 pass through to be disposed in the base layer 3. Each second conductor 32, 33 is separately electrically connected to the outer electrodes 35, 36 and the first connectors 22, 23. The second conductors 32, 33 can be formed by disposing through holes in the base layer 3 and filling conductive material in the through holes. The outer electrodes 35, 36 and the second conductors 32, 33 are good conductors and made of, but not limited to, gold, silver, copper or an alloy thereof or a mixture thereof. The degassing passage 38 is a passing hole passing through to be disposed in the base layer 3 and located at a corresponding position of the thermal resistance room 21.

Please refer to FIGS. 1-4. Each of the dielectric substrate 1A of the circuit layer 1, the thermal resistance layer 2, the base layer 3 and the top layer 4 is a ceramic layer. The base layer 3, the thermal resistance layer 2, the circuit layer 1 and the top layer 4 are closely superposed in sequence from bottom to top, and then the aforementioned layers are sintered to form a ceramic integrated mold by the LTCC process. The fuse wire 11 encapsulated in the ceramic integrated mold can be electrically connected to the outer electrodes 35. 36 exposedly disposed on the surface to be beneficial to installing the chip-type fuse in an electric circuit by soldering or the surface mount technology. In addition, the fuse wire 11 is disposed with an overcurrent melting portion 11A, and a thermal resistance room 21 with a chamber structure is disposed at a corresponding position of the overcurrent melting portion 11A, which not only blocks outward transmission of heat generated by the melted fuse wire 11 to concentrate the heat at the overcurrent melting portion 11A of the fuse wire 11, but also provides accommodation for molten shavings to avoid the situation of overflow of molten shavings or the capillary action causing the power to remain uninterrupted even after blowing. Accordingly, it can be ensured that the fuse wire 11 can surely blow out to implement the function of circuit protection when overload occurs. Furthermore, in the ceramic integrated mold, the degassing passage 38 of the base layer 3 communicates with the thermal resistance room 21. The degassing passage 38 can balance the air pressure of the thermal resistance room 21 and the outside to avoid the drawback of explosion of the ceramic integrated mold caused by the gas expansion generated by the instantaneous high temperature when the fuse wire 11 has blown out.

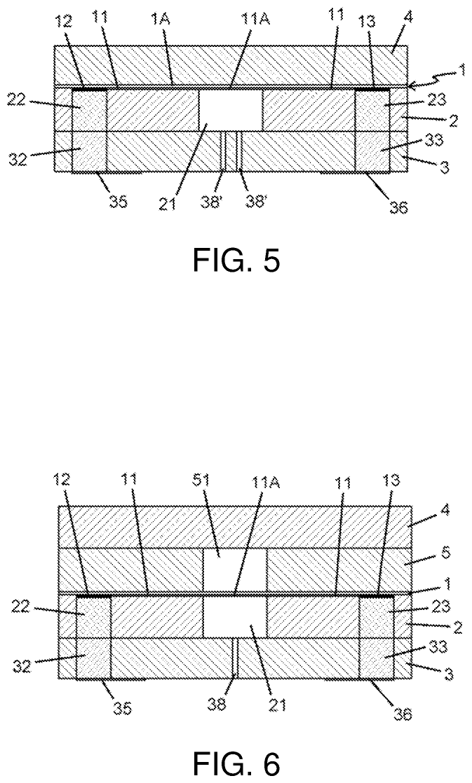

The aforementioned first embodiment discloses a typical structural arrangement of the chip-type fuse of the invention. Under the same inventive idea, there still are many available solutions. For example, FIG. 5 shows a cross-sectional view of the second embodiment of the invention, which has a structure similar to the first embodiment. The difference between the both is that the base layer 3 is disposed with multiple degassing passages 38′. The other structures which are the same will not be described again. In the second embodiment, there are two degassing passages 38′ passing through to be disposed in the base layer 3 and located at a corresponding position of the thermal resistance room 21. The communication between the multiple degassing passages 38′ and the thermal resistance room 21 can enhance the air pressure balance of the thermal resistance room 21 and the outside to completely overcome the problem of the gas expansion generated by the instantaneous high temperature when the fuse wire 11 has blown out.

In addition, FIG. 6 shows a cross-sectional view of the third embodiment of the chip-type fuse of the invention, which has a structure similar to the first embodiment. The other structures which are the same will not be described again. The difference between the both is that a second thermal resistance layer 5 is added. The second thermal resistance layer 5 is closely superposed between the circuit layer 1 and the top layer 4. The second thermal resistance layer 5 is a ceramic layer. The second thermal resistance layer 5 is disposed with a second thermal resistance room 51. The second thermal resistance room 51 is a hollow chamber with great thermal insulation and disposed at a corresponding position of the overcurrent melting portion 11A. In the third embodiment, each of the upper side and the lower side of a corresponding position of the overcurrent melting portion 11A of the fuse wire 11 is disposed with a thermal resistance room 51, 21 with a chamber structure to block outward transmission of heat generated by overcurrent to concentrate the heat at the overcurrent melting portion 11A of the fuse wire 11 so as to ensure the melting effect of the fuse wire 11 when overcurrent occurs.

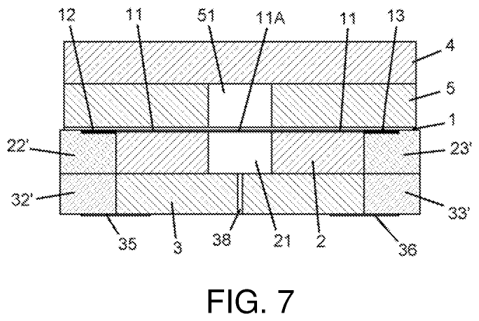

Moreover, FIG. 7 shows a cross-sectional view of the fourth embodiment of the chip-type fuse of the invention, which has a structure similar to the first and third embodiments. The other structures which are the same will not be described again. The difference from the aforementioned embodiments is that the conductors connecting the inner electrodes 12, 13 and the outer electrodes 35, 36 are disposed differently. Each of two sides of the thermal resistance layer 2 is disposed with a through trench. The two trenches are filled with conductive material to form first conductors 22′, 23′. The first conductors 22′, 23′ are separately electrically connected to the inner electrodes 12, 13 on the circuit layer 1. Also, each of two sides of the base layer 3 is disposed with a through trench. The two trenches are filled with conductive material to form second conductors 32′, 33′. The second conductors 32′, 33′ are separately electrically connected to the first conductors 22′, 23′ and the outer electrodes 35, 36 on the base layer 3. Accordingly, the fuse wire 11 encapsulated in the ceramic integrated mold can be electrically connected to the outer electrodes 35, 36 exposedly disposed on the surface.

While this disclosure has been described by means of specific embodiments, numerous modifications and variations could be made thereto by those skilled in the art without departing from the scope and spirit of this disclosure set forth in the claims.

What is claimed is:

1. A chip-type fuse comprising:
a circuit layer, comprising a dielectric substrate which is a ceramic layer, the dielectric substrate being disposed with a fuse wire and two inner electrodes, wherein the fuse wire is disposed with an overcurrent melting portion, and the two inner electrodes are separately disposed on two side edges of the circuit layer and electrically connected to two ends of the fuse wire;
a thermal resistance layer, being a ceramic layer, closely superposed to the circuit layer, disposed with a thermal resistance room and two first conductors, wherein the thermal resistance room is a hollow chamber and located at a corresponding position of the overcurrent melting portion, the two first conductors pass through to be disposed in the thermal resistance layer, and each first conductor is separately electrically connected to one of the inner electrodes;
a base layer, being a ceramic layer, closely superposed to the thermal resistance layer, disposed with two outer electrodes, two second conductors and a degassing passage, wherein the two outer electrodes are separately disposed on two side edges of a lower surface of the base layer, the two second conductors pass through to be disposed in the base layer, each second conductor is separately electrically connected to one of the outer electrodes and one of the first connectors, and the degassing passage passes through to be disposed in the base layer and located at a corresponding position of the thermal resistance room; and
a top layer, being a ceramic layer, and closely superposed to the circuit layer.

2. The chip-type fuse of claim 1, wherein the overcurrent melting portion is less than the fuse wire in circuit cross-section area.

3. The chip-type fuse of claim 1, wherein the overcurrent melting portion is lower than the fuse wire in material melting point.

4. The chip-type fuse of claim 1, wherein the overcurrent melting portion is higher than the fuse wire in material resistivity.

5. The chip-type fuse of claim 1, wherein the fuse wire is made of, but not limited to, silver, copper, tin or an alloy thereof or a mixture thereof.

6. The chip-type fuse of claim 1, wherein the first conductors and the second conductors are made of gold, silver, copper or an alloy thereof or a mixture thereof.

7. The chip-type fuse of claim 1, wherein the inner electrodes and the outer electrodes are made of gold, silver, copper or an alloy thereof or a mixture thereof.

8. The chip-type fuse of claim 1, wherein a second thermal resistance layer is closely superposed between the circuit layer and the top layer, and the second thermal resistance layer is a ceramic layer.

9. The chip-type fuse of claim 8, wherein the second thermal resistance layer is disposed with a second thermal resistance room, the second thermal resistance room is a hollow chamber and located at a corresponding position of the overcurrent melting portion.
